(19) United States
(12) Patent Application Publication
(10) Pub. No.: US 2015/0144100 A1
(43) Pub. Date: May 28, 2015

(54) Carburetor to Electronic Fuel Injection Conversion Distributor

(71) Applicant: Arthur Clyde Nutter, Brush Prairie, WA (US)

(72) Inventor: Arthur Clyde Nutter, Brush Prairie, WA (US)

(21) Appl. No.: 14/548,076

(22) Filed: Nov. 19, 2014

Related U.S. Application Data
(60) Provisional application No. 61/907,871, filed on Nov. 22, 2013.

(51) Int. Cl. F02M 41/00; F02M 61/16; F02D 41/30; F02M 51/00

(52) U.S. Cl. CPC F02M 41/00; F02M 51/00; F02M 61/168; F02D 41/30
USPC 123/403; 123/473

(57) ABSTRACT

A carburetor to electronic fuel injection conversion distributor is used in conjunction with a compatible engine control unit and a compatible throttle body so that carbureted engines can be converted into electronic fuel injection engines. The conversion distributor includes a stator distributor housing, a rotor shaft assembly, and a top housing as the rotor shaft assembly is rotatably engaged with the stator distributor housing. The rotor shaft assembly can be rotated through a camshaft of an internal combustion engine while the stator distributor housing is secured within the engine bay. The top housing is adjacently attached to the stator distributor housing, where the top housing can be a distributor cap or a distributor cover depending on the ignition system.

The current application claims a priority to the U.S. Provisional Patent application Ser. No. 61/907,871 filed on Nov. 22, 2013.

### FIELD OF THE INVENTION

The present invention relates generally to an ignition system of an internal combustion engine. More specifically, the present invention is able to convert a carburetor driven fuel system of an internal combustion engine into an electronic fuel injection system.

### BACKGROUND OF THE INVENTION

Most of the older vehicles that are ranging from the 1920s to early 1990s use a Kettering-style ignition system within their internal combustion engines, where the distributor was designed to time and distribute the spark to each of the cylinders according to the firing order of the engine. The distributor is typically driven off a gear on the camshaft. The carburetor contains jets that push the gasoline into the combustion chambers of the engine, and the amount of fuel that can flow through these jets depends completely upon the amount of air that can be pulled into the carburetor venture. The problem with the carburetor system is that the carburetor system is not able to monitor the air to fuel ratio for each individual cylinder in order to optimize the engine performance. The carburetor system also poses other problems such as low fuel economy and emission problem. The carburetors have largely replaced in the automotive industry by the fuel injection systems in order to overcome the aforementioned issues related to the carburetor systems. When vehicles with carbureted engines change over to electronic fuel injection engines, the retrofitting of the electronic fuel injection system can be expensive, inefficient, and complicated for most of the older vehicles.

It is therefore an objective of the present invention to provide a conversion distributor that allows the carbureted engine to easily and efficiently convert into the electronic fuel injection engine. In order to complete a functional setup within the internal combustion engine, the present invention is used in conjunction with a particular type of ECU, a throttle body, and a wiring harness as the particular type of ECU can include, but not limited to, warren, E-38, E-40, and E-67. The present invention uses a different design and forms the distributor bodies and shafts for various models of engines. The present invention uses cam shaft to spin the present invention's configuration of the cam and crank reluctors. The cam and crank reluctors may look like metal discs or cups as unit reluctors may have teeth, grooves or slots that the sensors pick up and convert to an electrical signal. These electrical signals are sent to the particular type of ECU, where the ECU determines the correct timing of spark, air intake, and fuel intake for each of the combustion chamber.

### BRIEF DESCRIPTION OF THE DRAWINGS

FIG. 1 is a perspective view of the present invention with the distributor cap as the top housing.

FIG. 2 is an exploded view of the present invention with the distributor cap as the top housing.

FIG. 3 is a side view of the present invention with the distributor cap as the top housing, wherein dash lines showing the main shaft, the cam reluctor, rotor arm and the crank reluctor.

FIG. 4 is a side view of the present invention with the distributor cap as the top housing, showing the plane upon which a cross sectional view is taken shown in FIG. 5.

FIG. 5 is a cross section view of the present invention with the distributor cap as the top housing taken along line A-A of FIG. 4.

FIG. 6 is a perspective view of the stator distributor housing of the present invention.

FIG. 7 is a top view of the stator distributor housing of the present invention.

FIG. 8 is a perspective view of the rotor shaft assembly of the present invention.

FIG. 9 is a side view of the rotor shaft assembly of the present invention.

FIG. 10 is a perspective view of the present invention with the distributor cover as the top housing.

FIG. 11 is an exploded view of the present invention with the distributor cover as the top housing.

FIG. 12 is a basic electronic schematic of the present invention, wherein the top housing is the distributor cap.

FIG. 13 is a basic electronic schematic of the present invention, wherein the top housing is the distributor cover.

### DETAIL DESCRIPTIONS OF THE INVENTION

All illustrations of the drawings are for the purpose of describing selected versions of the present invention and are not intended to limit the scope of the present invention.

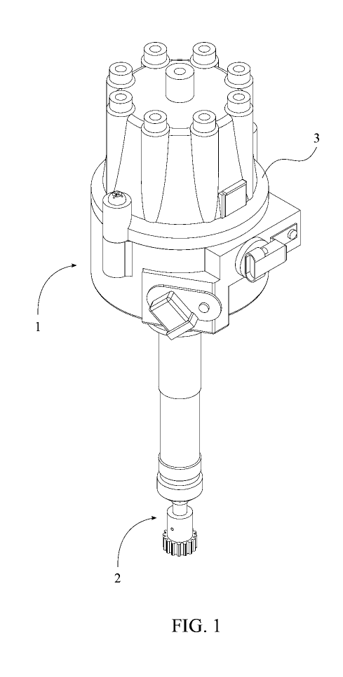

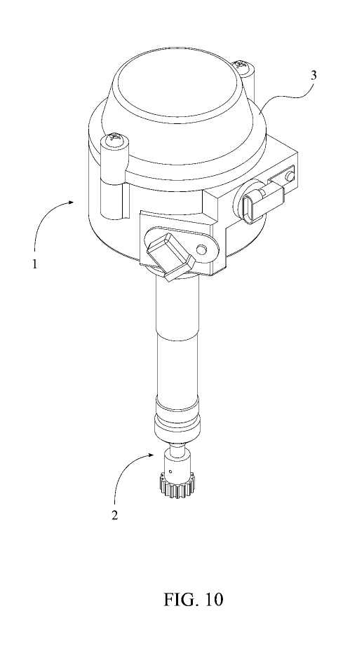

The present invention is a carburetor to electronic fuel injection conversion distributor as the present invention enables carbureted combustion engines to be converted into electronic fuel injected combustion engines. The present invention is used in conjunction with a compatible engine control unit 4 (ECU) and a compatible throttle body 5 so that the present invention is able efficiently function with the internal combustion engine. The ECU 4 can include, but not limited to, warren, E-38, E-40, and E-67. The present invention comprises a stator distributor housing 1, a rotor shaft assembly 2, and a top housing 3 as shown in FIG. 1 and FIG. 10. In reference to the general configuration of the present invention, the rotor shaft assembly 2 is rotatably engaged with the stator distributor housing 1 so that the rotor shaft assembly 2 can be rotated through a camshaft of an internal combustion engine while the stator distributor housing 1 is secured within the engine bay. The top housing 3 is adjacently attached to the stator distributor housing 1, where the top housing 3 can be a distributor cap 32 or a distributor cover 31 depending on the ignition system. For example, when the present invention is applied with a single coil system, the distributor cap 32 is utilized as the top housing 3. However, when the present invention is applied with a plurality of coil packs, the distributor cover 31 is utilized as the top housing 3.

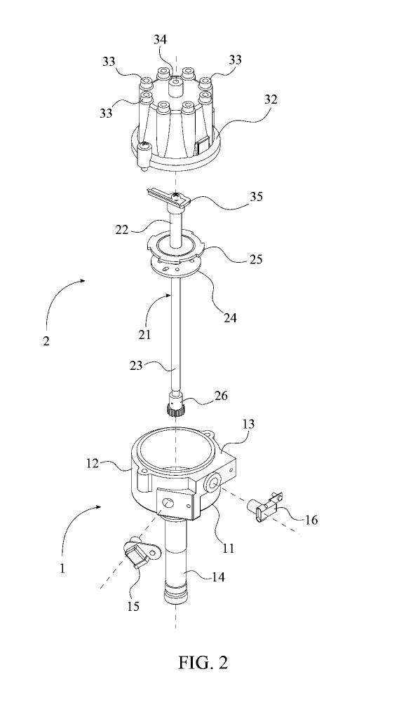

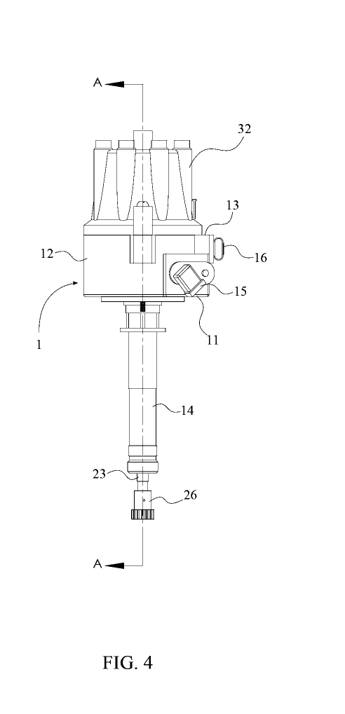

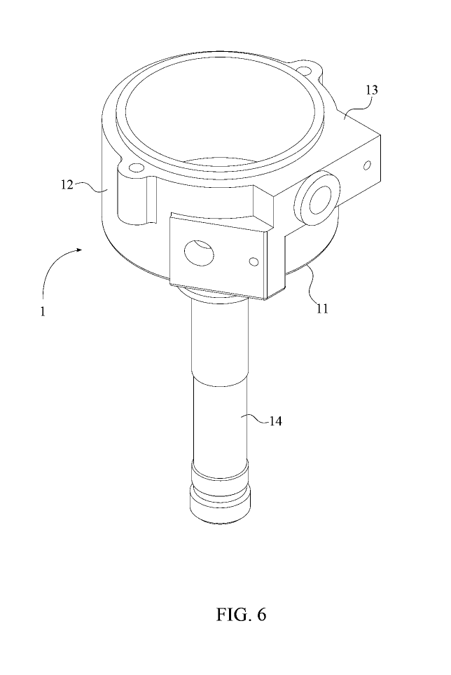

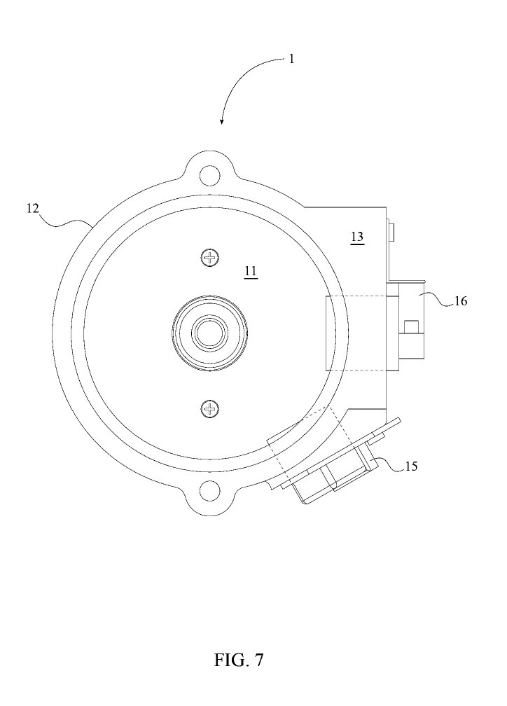

The stator distributor housing 1 that functions as the foundation member for the present invention provides necessary internal and external surface area so that the rest of the components of the present invention can be configured upon the stator distributor housing 1. In reference to FIG. 1-FIG. 7, the stator distributor housing 1 comprises a base plate 11, a lateral wall 12, a shaft sleeve 14, a crank position sensor 16, and a cam position sensor 15. The lateral wall 12 is perimetrically positioned around the base plate 11 in order to form the top half of the stator distributor housing 1. The shaft sleeve 14 is concentrically attached with the base plate 11 opposite of the lateral wall 12 so that the bottom half of the stator distributor housing 1 can be completed. More specifically, a top opening of the stator distributor housing 1 provides access to the top half of the stator distributor housing 1 while a central opening of the base plate 11 enables the shaft sleeve 14 to be accessed from the top half of the stator distributor housing 1. The cam position sensor 15 is traversed through the lateral wall 12 and adjacently positioned with the base plate 11. Since the rotor shaft assembly 2 is rotated by the camshaft, the cam position sensor 15 is able to determine the position of the camshaft. The crank position sensor 16 is traversed through the lateral wall 12 and adjacently positioned with a top edge 13 of the lateral wall 12. Since the rotor shaft assembly 2 is rotated by the camshaft, the crank position sensor 16 is able to determine the position or the rotational speed of the crankshaft. The exact position of the camshaft and the crankshaft are significant for the process of converting a carbureted engine into an electronic fuel injection engine so that the fuel can be injected into each of the combustion chamber according to the firing order of the cylinders.

The cam position sensor 15 and the crank position sensor 16 provide input data to the ECU 4 as the cam position sensor 15 and the crank position sensor 16 are both electrically connected with the ECU 4. Once the ECU 4 receives input data from the cam position sensor 15 and the crank position sensor 16, the ECU 4 is able to electronically control timing and other engine parameters that would have been manually adjusted through a standard distributor. The ECU 4 is electrically connected with the throttle body 5 as the throttle body 5 is mounted to the internal combustion engine. As a result, the throttle body 5 is able to control the air intake of the internal combustion engine through a throttle position sensor of the throttle body 5 according to the specification of the ECU 4 so that the present invention is able to attain an electronic fuel injection system. For example, when the ECU 4 retrieves data from the cam position sensor 15 and the crank position sensor 16, the retrieved data is interpreted and the series of actuators are adjusted, wherein the ECU 4 makes rapid calculations to determine the amount of fuel to be delivered to each cylinder for every combustion cycle and calculate the instantaneous timing of the ignition spark for every combustion event.

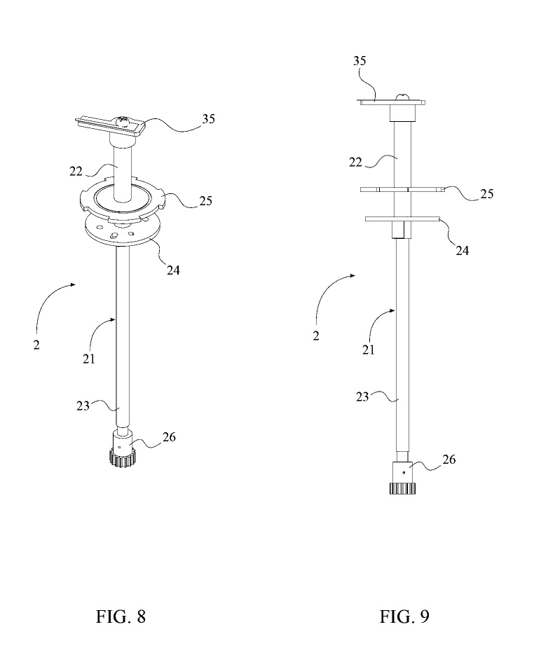

In reference to FIG. 8 and FIG. 9, the rotor shaft assembly 2 that is rotated through the camshaft of the internal combustion engine comprises a main shaft 21, a crank reluctor 25, a cam reluctor 24, and a drive gear 26. The main shaft 21 that functions as the rotating axle for the rotor shaft assembly 2 comprises a first portion 22 and a second portion 23. The first portion 22 and the second portion 23 are concentrically positioned with each other along the main shaft 21 forming a single rotating axle so that the crank reluctor 25, the cam reluctor 24, and the drive gear 26 can be connected around the main shaft 21. The diameter of the first portion 22 is also larger than the diameter of the second portion 23, where the diameter difference between the first portion 22 and the second portion 23 enables the main shaft 21 to be rotatably positioned within the stator distributor housing 1 along with the supplemented bearings. More specifically, the rotor shaft assembly 2 is rotatably engaged with the base plate 11 and the shaft sleeve 14 in such a way that the first portion 22 and the second portion 23 are concentrically positioned with the central opening of the base plate 11. Additionally, the first portion 22 is completely enclosed by the base plate 11, the lateral wall 12, and the top housing 3 while the second portion 23 is partially enclosed by the shaft sleeve 14 and outwardly extended from the shaft sleeve 14 opposite of the base plate 11.

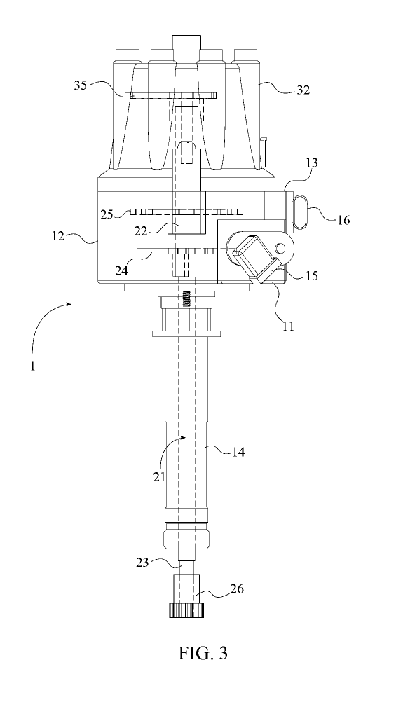

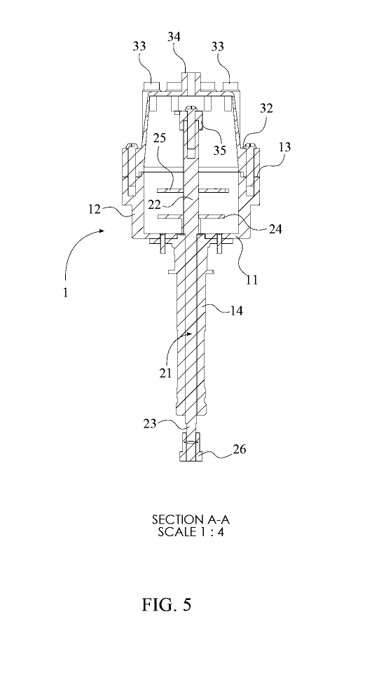

In reference to FIG. 3, FIG. 5, and FIG. 9, the cam reluctor 24, which enables the cam position sensor 15 to get the input data throughout the rotation of the rotor shaft assembly 2, is concentrically connected around the first portion 22 and adjacently positioned with the base plate 11 and cam position sensor 15. More specifically, the cam position sensor 15 that functions as a hall-effect sensor is closely mounted with the outer diameter of the cam reluctor 24 so that the cam position sensor 15 is able to send out a pulse to the ECU 4 when at least one cam tooth of the cam reluctor 24 passes by the cam position sensor 15. In reference to FIG. 3, FIG. 5, and FIG. 9, the crank reluctor 25, which enables the crank position sensor 16 to get the input data throughout the rotation of the rotor shaft assembly 2, is concentrically connected around the first portion 22 adjacent to the cam reluctor 24. The crank reluctor 25 is also adjacently positioned with the top edge 13 of lateral wall 12 and crank position sensor 16. More specifically, the crank position sensor 16 that functions as a hall-effect sensor is closely mounted with the outer diameter of the crank reluctor 25 so that the crank position sensor 16 is able to send out a pulse to the ECU 4 when each crank teeth of the crank reluctor 25 passes by the crank position sensor 16.

In reference to FIG. 3, the drive gear 26 allows the rotor shaft assembly 2 to engage with the camshaft of the internal combustion engine so that the cam reluctor 24 and the crank reluctor 25 can be rotated through the main shaft 21. The drive gear 26 is concentrically connected around the second portion 23 and oppositely positioned of the cam reluctor 24 and the crank reluctor 25 across the main shaft 21. More specifically, the drive gear 26 is adjacently positioned with the shaft sleeve 14 and connected around the second portion 23 that extends through the shaft sleeve 14.

The at least one cam tooth of the cam reluctor 24 and the crank teeth of the crank reluctor 25 can differ from one internal combustion engine to another. Depending on the configuration of the internal combustion engine, the at least one cam tooth can comprise a single cam tooth or four cam teeth. However, the crank teeth can comprise three crank teeth, four crank teeth, twenty four crank teeth, or fifty eight crank teeth. The correct combination of the cam reluctor 24 and the crank reluctor 25 is strictly based upon the internal combustion engine, where one does not precede the other. Following is a list for the possible pairing combinations of the cam reluctor 24 and crank reluctor 25:

1. The cam reluctor 24 with the single cam tooth is paired with the crank reluctor 25 that has twenty four crank teeth.

2. The cam reluctor 24 with the single cam tooth is paired with the crank reluctor 25 that has three crank teeth.

3. The cam reluctor 24 with four cam teeth is paired with the crank reluctor 25 that has fifty eight crank teeth.

4. The cam reluctor 24 with four cam teeth is paired with the crank reluctor 25 that has four crank teeth.

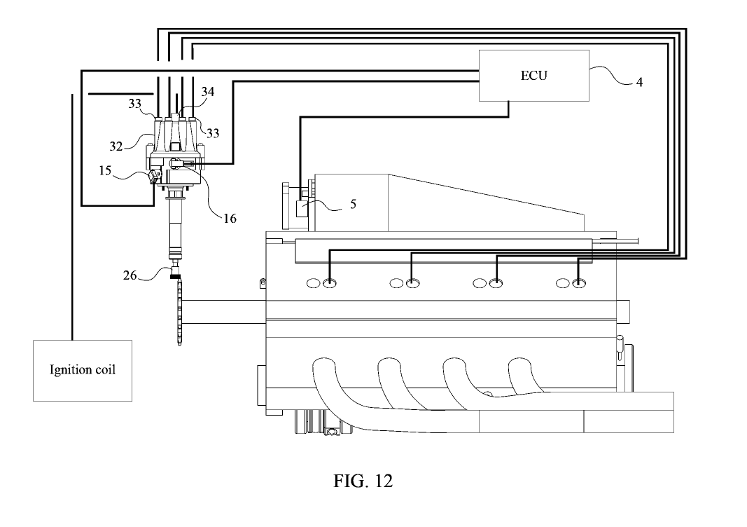

In reference to FIG. 1-FIG. 5, when the top housing 3 of the present invention is the distributor cap 32, the present invention is used in conjunction with an internal combustion engine that has the single coil system. The rotor shaft assembly 2 further comprises a rotor arm 35 so that the rotor arm 35 is able to provide a high tension electric current to the spark plug of each cylinder of the internal combustion engine. More specifically, the rotor arm 35 is connected to the first portion 22 and adjacently positioned with the crank reluctor 25 opposite of the cam reluctor 24. In reference to FIG. 12, the rotor arm 35 is electrically connected with a coil terminal 34 of the distributor cap 32 so that the rotor arm 35 is able to distribute electrical current to a plurality of spark plug terminals 33 of the distributor cap 32. In order for the present invention to properly function within the distributor cap 32, the coil terminal 34 is electrically connected with the ignition coil while each of the plurality of spark plug terminals 33 is electrically connected with the internal combustion engine through a spark plug wire. When the main shaft 21 rotates according to the camshaft, the rotor arm 35 also rotates according to the main shaft 21 so that the rotor arm 35 is able to pass each of the plurality of spark plug terminals 33. When the rotor arm 35 passes each of the plurality of spark plug terminals 33, the electrical current from the ignition coil is able to jump from the rotor arm 35 to each of the plurality of spark plug terminals 33. Then the electrical current can power the spark plug of each cylinder according to the correct firing order as the electrical current is traveled through the spark plug wires.

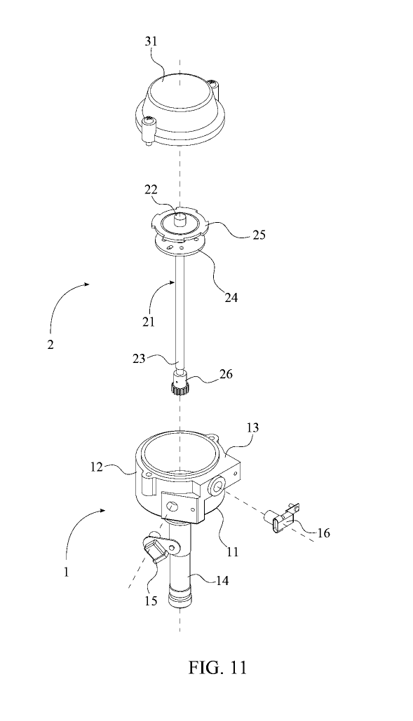

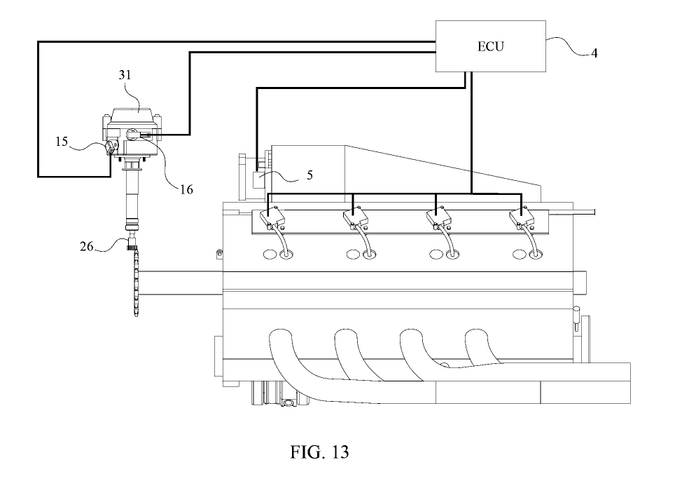

In reference to FIG. 10, FIG. 11, and FIG. 13, when the top housing 3 of the present invention is the distributor cover 31, the present invention is used in conjunction with an internal combustion engine that has the plurality of coil packs. The distributor cover 31 of the present invention is connected to the lateral wall 12 so that the distributor cover 31 is able to protect the components within the stator distributor housing 1. In order for the present invention to properly function with the distributor cover 31, the cam position sensor 15 and the crank position sensor 16 jointly determine the correct firing order of the internal combustion engine so that the ECU 4 can power the spark plug of each cylinder through the plurality of coli packs.

Although the invention has been explained in relation to its preferred embodiment, it is to be understood that many other possible modifications and variations can be made without departing from the spirit and scope of the invention as hereinafter claimed.

What is claimed is:

1. A carburetor to electronic fuel injection conversion distributor comprises:
a stator distributor housing;
a rotor shaft assembly;
a top housing;
the stator distributor housing comprises a base plate, a lateral wall, a shaft sleeve, a crank position sensor, and a cam position sensor;
the rotor shaft assembly comprises a main shaft, a crank reluctor, a cam reluctor, and a drive gear;
the rotor shaft assembly being rotatably engaged with the stator distributor housing; and
the top housing being adjacently attached to the stator distributor housing.

2. The carburetor to electronic fuel injection conversion distributor as claimed in claim 1 comprises:
the lateral wall being perimetrically positioned around the base plate;
the shaft sleeve being concentrically attached with the base plate opposite of the lateral wall;
the crank position sensor traversing through the lateral wall;
the crank position sensor being adjacently positioned with a top edge of the lateral wall;
the cam position sensor traversing through the lateral wall; and
the cam position sensor being adjacently positioned with the base plate.

3. The carburetor to electronic fuel injection conversion distributor as claimed in claim 1 comprises:
the cam position sensor being electrically connected with an engine control module (ECU); and
the crank position sensor being electrically connected with the ECU.

4. The carburetor to electronic fuel injection conversion distributor as claimed in claim 3, wherein the ECU is electrically connected with a throttle body in order to control the air intake of the internal combustion engine.

5. The carburetor to electronic fuel injection conversion distributor as claimed in claim 1 comprises:
the main shaft comprises a first portion and a second portion;
the first portion and the second portion being concentrically positioned with each other along the main shaft;
the cam reluctor being concentrically connected around the first portion;
the crank reluctor being concentrically connected around the first portion adjacent to the cam reluctor;
the drive gear being concentrically connected around the second portion; and
the drive gear being oppositely positioned of the cam reluctor and the crank reluctor across the main shaft.

6. The carburetor to electronic fuel injection conversion distributor as claimed in claim 1 comprises:
the cam reluctor being adjacently positioned with the base plate;
the cam reluctor being adjacently positioned with the cam position sensor;
the crank reluctor being adjacently positioned with a top edge of the lateral wall; and
the crank reluctor being adjacently positioned with the crank position sensor.

7. The carburetor to electronic fuel injection conversion distributor as claimed in claim 1 comprises:
a first portion and a second portion of the main shaft being concentrically positioned with the base plate;
the first portion being completely enclosed by the base plate, the lateral wall, and the top housing;
the second portion being partially enclosed by the shaft sleeve; and
the drive gear being adjacently positioned with the shaft sleeve.

8. The carburetor to electronic fuel injection conversion distributor as claimed in claim 6, wherein the drive gear is engaged with a camshaft of an internal combustion engine in order to rotate the cam reluctor and the crank reluctor through the main shaft.

9. The carburetor to electronic fuel injection conversion distributor as claimed in claim 1 comprises:
the top housing being a distributor cap, wherein the distributor cap is electrically connected with each of the spark plugs of an internal combustion engine through a plurality of spark plug wires;
the rotor shaft assembly further comprises a rotor arm;
the rotor arm being connected to the first portion; and
the rotor arm being adjacently positioned with the crank reluctor opposite of the cam reluctor, wherein the rotor arm electrically connects a coil terminal of the distributor cap with a plurality of spark plug terminals of the distributor cap according to the firing order of the internal combustion engine.

10. The carburetor to electronic fuel injection conversion distributor as claimed in claim 1 comprises:
the top housing being a distributor cover, wherein the distributor cover protects the components within the stator distributor housing while the cam position sensor and the crank position sensor determine the firing order of an internal combustion engine through a plurality of coil packs.

11. A carburetor to electronic fuel injection conversion distributor comprises:
a stator distributor housing;
a rotor shaft assembly;
a top housing;
the stator distributor housing comprises a base plate, a lateral wall, a shaft sleeve, a crank position sensor, and a cam position sensor;
the rotor shaft assembly comprises a main shaft, a crank reluctor, a cam reluctor, and a drive gear;
the lateral wall being perimetrically positioned around the base plate;
the shaft sleeve being concentrically attached with the base plate opposite of the lateral wall;
the crank position sensor traversing through the lateral wall;
the crank position sensor being adjacently positioned with a top edge of the lateral wall;
the cam position sensor traversing through the lateral wall;
the cam position sensor being adjacently positioned with the base plate;
the rotor shaft assembly being rotatably engaged with the stator distributor housing through the base plate; and
the top housing being adjacently attached to the stator distributor housing.

12. The carburetor to electronic fuel injection conversion distributor as claimed in claim 11 comprises:
the cam position sensor being electrically connected with an engine control module (ECU); and
the crank position sensor being electrically connected with the ECU.

13. The carburetor to electronic fuel injection conversion distributor as claimed in claim 12, wherein the ECU is electrically connected with a throttle body in order to control the air intake of the internal combustion engine.

14. The carburetor to electronic fuel injection conversion distributor as claimed in claim 11 comprises:
the main shaft comprises a first portion and a second portion;
the first portion and the second portion being concentrically positioned with each other along the main shaft;
the cam reluctor being concentrically connected around the first portion;
the crank reluctor being concentrically connected around the first portion adjacent to the cam reluctor;
the drive gear being concentrically connected around the second portion; and
the drive gear being oppositely positioned of the cam reluctor and the crank reluctor across the main shaft.

15. The carburetor to electronic fuel injection conversion distributor as claimed in claim 11 comprises:
the cam reluctor being adjacently positioned with the base plate;
the cam reluctor being adjacently positioned with the cam position sensor;
the crank reluctor being adjacently positioned with a top edge of the lateral wall; and
the crank reluctor being adjacently positioned with the crank position sensor.

16. The carburetor to electronic fuel injection conversion distributor as claimed in claim 11 comprises:
a first portion and a second portion of the main shaft being concentrically positioned with the base plate;
the first portion being completely enclosed by the base plate, the lateral wall, and the top housing;
the second portion being partially enclosed by the shaft sleeve; and
the drive gear being adjacently positioned with the shaft sleeve.

17. The carburetor to electronic fuel injection conversion distributor as claimed in claim 16, wherein the drive gear is engaged with a camshaft of an internal combustion engine in order to rotate the cam reluctor and the crank reluctor through the main shaft.

18. The carburetor to electronic fuel injection conversion distributor as claimed in claim 11 comprises:
the top housing being a distributor cap, wherein the distributor cap is electrically connected with each of the spark plugs of an internal combustion engine through a plurality of spark plug wires;
the rotor shaft assembly further comprises a rotor arm;
the rotor arm being connected to the first portion; and
the rotor arm being adjacently positioned with the crank reluctor opposite of the cam reluctor, wherein the rotor arm electrically connects a coil terminal of the distributor cap with a plurality of spark plug terminals of the distributor cap according to the firing order of the internal combustion engine.

19. The carburetor to electronic fuel injection conversion distributor as claimed in claim 11 comprises:
the top housing being a distributor cover, wherein the distributor cover protects the components within the stator distributor housing while the cam position sensor and the crank position sensor determine the firing order of an internal combustion engine through a plurality of coil packs.
